(19) United States
(12) Patent Application Publication
(10) Pub. No.: US 2007/0047542 A1
(43) Pub. Date: Mar. 1, 2007

(54) Real-time audio-visual quality monitoring in a network

(75) Inventor: Vivek Thukral, Palo Alto, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/215,508

(22) Filed: Aug. 30, 2005

(51) Int. Cl. H04L 12/28

(52) U.S. Cl. 370/389

(57) ABSTRACT

Systems and methods are described for real-time audio-visual quality monitoring in a network. In one implementation, a system displays an IPTV network in a user interface as a tree consisting of the nodes and the links between nodes of the IPTV network. When a user selects one or more test points, such as one of the links, the system displays a real-time rendering of the audio-visual stream flowing at the link or at each of the endpoints of the link so that the user can make a visual assessment or comparison of the audio-visual quality of the rendered audio-visual content.

### RELATED APPLICATION

The present application is related to U.S. patent application Ser. No. ______ (Atty Docket # MS1-2647US) to Vivek Thukral, entitled “Real-time IPTV Channel Health Monitoring,” filed on Aug. 30, 2005 and incorporated herein by reference in its entirety.

### BACKGROUND

Conventional systems for monitoring the “health” of components and data packet flow in Internet Protocol (IP)-based networks compile an error log from the components in order to perform maintenance during off hours at night. But as IP television (IPTV) systems are rolled out, a new problem in terms of service and monitoring is created. Television viewing inherently demands higher reliability and faster response time than mere Internet use. In addition, audio-visual quality (“AV quality”) is a new feature of the “health” of IPTV networks that must also be tracked in addition to component health.

Conventional tools for monitoring network health only provide a limited picture of an IPTV system's health. The conventional tools are not able to locate even conventional problems very quickly. Nor are the conventional tools able to monitor or understand problems that occur in the television video frames that are being carried by IP data packets on the network. That is, they are not able to abstract or interpret television audio-visual (AV) quality problems on levels that are important for maintaining the IPTV network at satisfactory reliability and availability for subscribers.

### SUMMARY

Systems and methods are described for real-time audio-visual quality monitoring in a network. In one implementation, a system displays an IPTV network in a user interface as a tree consisting of the nodes and the links between nodes of the IPTV network. When a user selects one or more test points, such as one of the links, the system displays a real-time rendering of the audio-visual stream flowing at the link or at each of the endpoints of the link so that the user can make a visual assessment or comparison of the audio-visual quality of the rendered audio-visual content.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagram of an exemplary audio-visual quality monitoring engine in relation to an Internet Protocol television network.

FIG. 2 is a diagram of the exemplary audio-visual quality monitoring engine in relation to a hierarchically arranged Internet Protocol television network.

FIG. 3 is a block diagram of an exemplary audio-visual quality monitoring engine for Internet Protocol television.

FIG. 4 is a diagram of the exemplary user interface including a pane for visualizing audio-visual quality of an audio-visual stream.

FIG. 5 is a diagram of an exemplary user interface including side-by-side panes for visually comparing audio-visual qualities of audio-visual streams from endpoints of a network link.

FIG. 6 is a diagram of an exemplary user interface including side-by-side panes for visually comparing audio-visual qualities of audio-visual streams from either side of a network node.

FIG. 7 is a diagram of an exemplary user interface including side-by-side panes for visually comparing audio-visual qualities of audio-visual streams from two different network links.

FIG. 8 is a flow diagram of an exemplary method of real-time audio-visual monitoring for Internet Protocol television.

### DETAILED DESCRIPTION

Overview

Described herein are systems and methods for exemplary real-time audio-visual (AV) quality monitoring in Internet Protocol (IP) networks. An exemplary user interface (UI) enables service providers to understand the audio-visual (AV) quality being delivered by their network at any time and at any point in the network. The system allows an operator to view what the client is seeing or not seeing at that very moment and to make comparisons based on data and visualizations of the video frames from anywhere on an entire channel path. The operator can perform diagnostics of AV quality anywhere on the channel path, to quickly determine the location and cause of a problem.

The exemplary AV quality monitoring uses multicast addresses, and does not need channel information to show the quality of a link. In an IP television (IPTV) implementation, however, the real-time network packet streams flowing through the nodes and links of the IPTV network are displayed in a topographic map tree distribution that is easily collapsible into different levels of view. Selecting a link, for example, by double-clicking on part of the tree in the UI, spawns a window showing the real-time rendered audio-visual content at that point in the network.

In one implementation, the links between network nodes are displayed color coded for their AV health. Then, if a link's AV quality degrades, as indicated by a color change, the human operator can select the link, e.g., by double-clicking, and the exemplary AV quality monitoring system will provide two different windows of real-time video frames of the picture being delivered and received between the endpoints of the link. This allows the operator to visually check the quality of the video. In one implementation, the links are instrumented to provide frame dropping and other AV quality information, e.g., in text or icon form on the UI or in the spawned window showing the live video.

The exemplary real-time AV quality monitoring system can be used separately or integrated into an exemplary system for proactively measuring both component health and AV quality, as described in U.S. patent application Ser. No. ______ to Vivek Thukral, entitled “Real-time IPTV Channel Health Monitoring,” filed on Aug. 30, 2005 (hereinafter, the “Thukral reference”).

Exemplary System

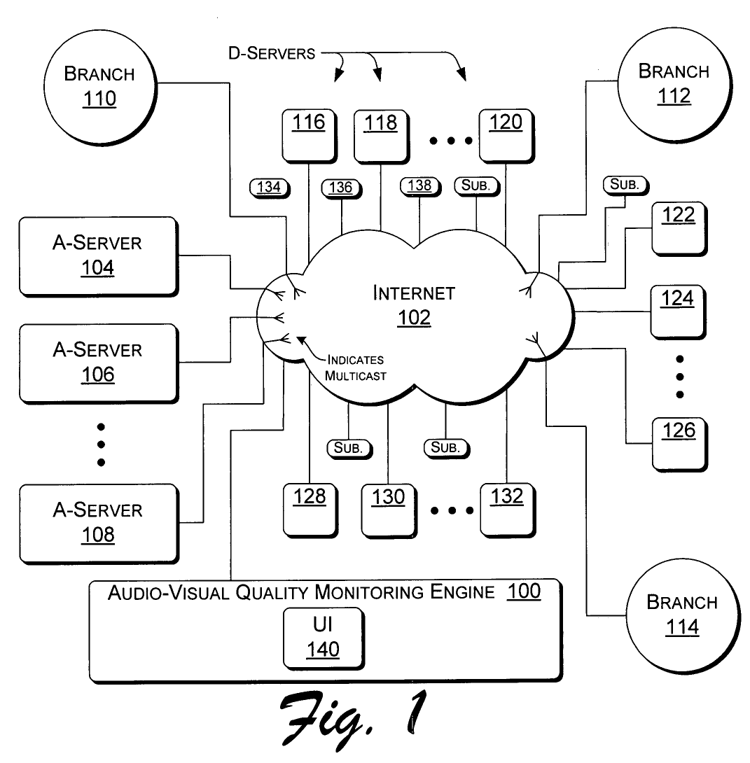

FIG. 1 shows an exemplary AV quality monitoring engine 100 as it relates to an IPTV system and to the Internet 102. The various components of the IPTV system can dwell in different geographical locations but are each connected to the Internet 102. Because relation to the Internet is being shown and the hierarchical character of an IPTV network, the distribution path of a given televised channel is not always obvious from a schematic such as illustrated in FIG. 1. The backend of the IPTV system typically consists of source servers, such as A-Servers 104, 106, 108, where one A-Server node originates or “hosts” a single channel of a channel lineup. That is, an A-Server (e.g., 104) originates the IP multicast of video frame packets for its respective channel.

Each A-Server 104 multicasts to branch nodes, such as branch servers 110, 112, and 114. The branch servers (e.g., 110) serve as connecting nodes between one or more of the A-Servers 104 and a main division of the IPTV network, such as a main divisional branch 110 that supplies multiple television channels to an entire city. An individual branch 110 multicasts one or more channels to a cluster of end server nodes, known as D-Servers (116, 118, . . . 120) on the outer “edge” of the IPTV network. There may be many branches (110, 112, . . . 114) each serving a cluster of D-Servers (e.g., 116), such as branch 112 serving the cluster of D-Servers 122, 124, . . . 126 and branch 114 serving the cluster of D-Servers 128, 130, . . . 132. Finally, individual subscribers (e.g., 134, 136 . . . 138) are served an IP television channel via one of the individual D-Servers 116.

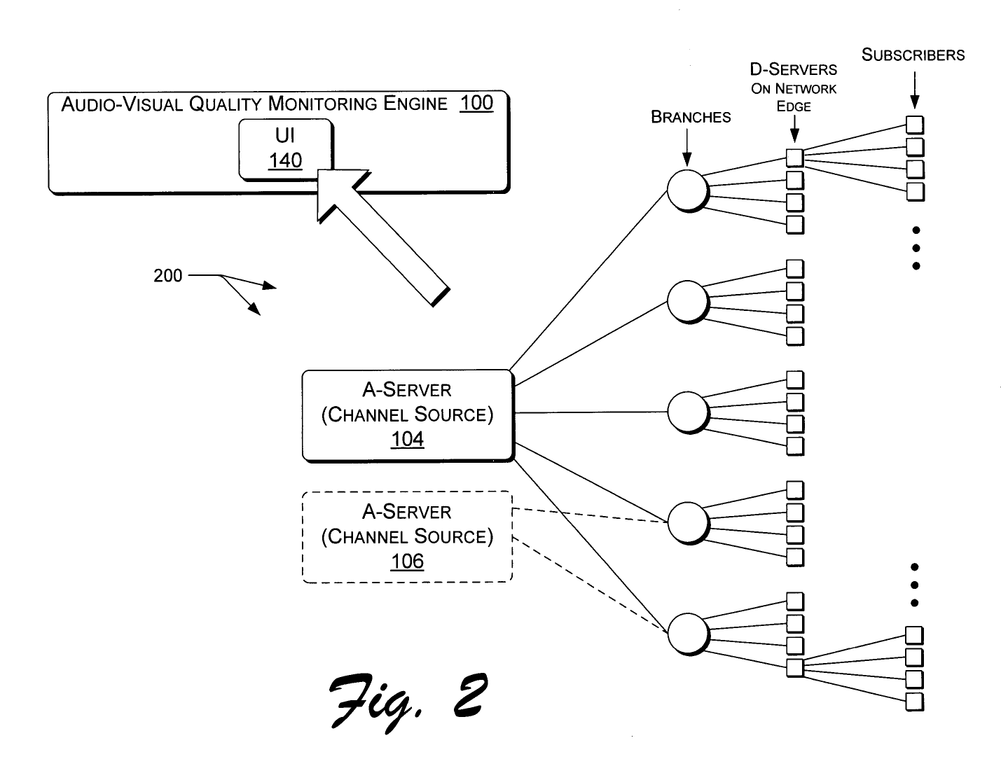

FIG. 2 shows the IPTV network and the exemplary AV quality monitoring engine 100 of FIG. 1, but this time the IPTV network is arranged according to interrelationships between nodes in a hierarchical tree structure 200 instead of in relation to the Internet 102.

The various stages of the hierarchical tree structure 200 constitute the tiers of the IPTV network—such as an A-Server tier, a branches tier, a D-Server tier, and a subscribers tier. Typically the nodes constituting the tiers are also the endpoints of the links between the tiers, and it is these endpoints and links that are most typically represented in the hierarchical tree structure 200, to be displayed in collapsible and manipulable form in the exemplary UI 140. Generally, in the IPTV network itself, each link to be represented in the UI 140 actually consists at least in part of the Internet 102, as previously shown in FIG. 1, but the Internet nature of a link does not need to be shown when the link is represented as a line in the exemplary UI 140. However, the AV health of a link may be shown by color coding each line representing a link.

Exemplary Engine

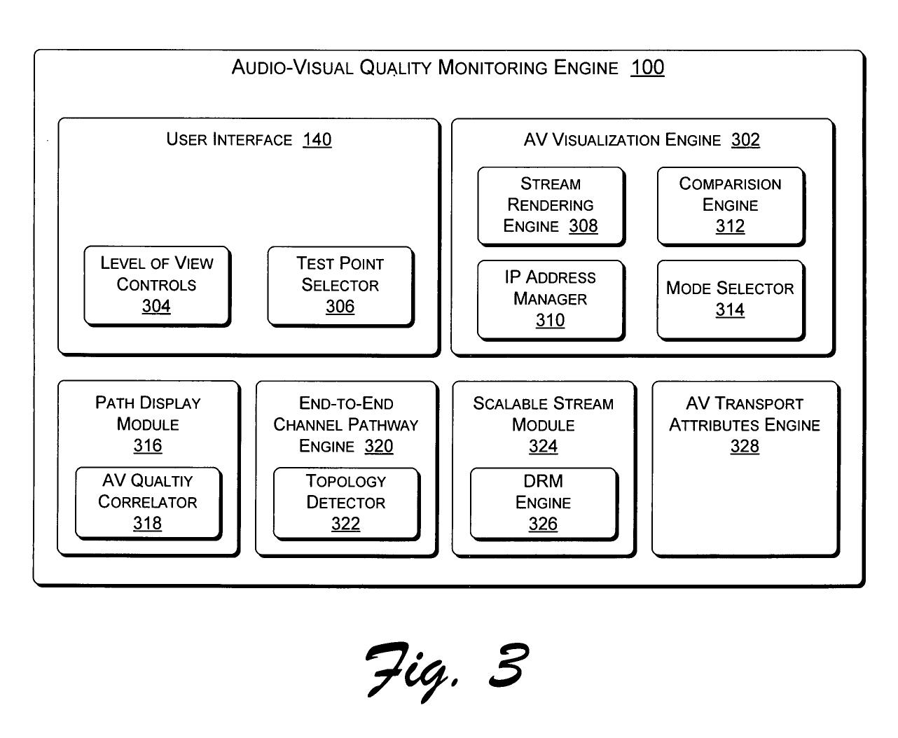

FIG. 3 shows the exemplary AV quality monitoring engine 100 of FIGS. 1 and 2 in greater detail. The illustrated configuration of the exemplary AV quality monitoring engine 100 is meant to provide one example arrangement for the sake of overview. Many other arrangements of the illustrated components, or similar components, are possible within the scope of the subject matter. Such an AV quality monitoring engine 100 can be executed in hardware, software, or combinations of hardware, software, firmware, etc.

The AV quality monitoring engine 100 can enable measurement of the quality of AV streams across network tiers, e.g., from a central location. For example, by double-clicking on displayed links, the AV quality monitoring engine 100 displays a separate video dialogue of rendered AV flowing between link nodes. Such a live sample of the AV stream can be instrumented to provide feedback from network, demux and decoder stack sources, which can then be correlated with observed picture quality. The AV quality monitoring engine 100 also provides multiple simultaneous displays of rendered AV content from multiple links for side-by-side comparison of their visual qualities.

In one implementation, the AV quality monitoring engine 100 includes the user interface 140 introduced in FIGS. 1 and 2, an AV visualization engine 302, and may include several other components that drive one or both of the user interface 140 and the AV visualization engine. The user interface 140 typically includes level of view controls 304 and a test point selector 306 for selecting specific points in the network at which to monitor AV quality.

The AV visualization engine 302 may further include a stream rendering engine 308, an IP address manager 310, a comparison engine 312, and a mode selector 314. Other components that may be included in the exemplary AV quality monitoring engine 100 including a path display module 316 that may further include an AV quality correlator 318; an end-to-end channel pathway engine 320 that may further include a topology detector 322; a scalable stream module 324 that may further include a digital rights management (DRM) engine 326; and an AV transport attributes engine 328.

The end-to-end channel pathway engine 320 has a topology detector 322 that discovers the distribution path of a televised channel from backend source to subscriber, and displays in the UI 140 a highly manipulable and logically organized representation—e.g., the hierarchical tree 200—of the entire IPTV network (or a relevant segment), at least for one channel at a time. The topology detector 322 may use standard IP techniques to discover a channel distribution path. With IP/TCP, for example, it is relatively easy to discover a succession of nodes that describe the route of an IP packet and build a node topology, or in this case, the channel path, all the way to the subscriber without actually communicating with, for example, the subscriber's set-top box.

Logic of the path display module 316 can control the collapsing and expanding of the displayed tree 200 based on a default or a detected problem. The operator can also manually collapse and expand the displayed tree 200. In tracing a problem, for example, the test point selector 306 may consist of the operator double-clicking on a displayed link with a mouse.

The AV quality monitoring engine 100 can be used in a troubleshooting capacity to trace a problem or just to monitor the status of the AV quality when there is no problem on the network. In a typical scenario, the operator can select the level of view of the hierarchical tree 200 representing the network via the level of view controls 304. A particular level of view, or a particular part of the network, may also be automatically selected by the AV transport attributes engine 328 and the path display module 316. That is, when the AV transport attributes engine 328 detects or counts an AV transport attribute that exceeds a threshold, thus indicating a problem, it may signal the path display module 316 to post the relevant part of the hierarchical tree 200 to the UI 140 so that the problem can be viewed.

The AV transport attributes engine 328 seeks information about AV frames and their quality, not necessarily about packet delivery as such and component health as such. The AV transport attributes to be monitored can include packet count, packet discontinuity count, video frame rate, video frame count, and video frame discontinuity count, among others. For example, encoding and decoding problems can cause packet discontinuity and/or frame discontinuity, which affect the video quality. When a data packet is lost on the network, then the next frame may be marked as discontinuous (i.e., “one frame was lost”). The effect of many discontinuous frames is obvious to a viewer and then AV quality is compromised. Thus, the AV transport attributes engine 328 can look into the IP stream and monitor the AV quality of the stream itself in each link of the network (between nodes).

In one implementation, described more fully in the Thukral reference introduced above, no matter which part of the network or level of view is currently selected, the AV transport attributes engine 328 senses the IP transport health for each link insofar as it can be ascertained from transport attributes, and sends the information to the path display module 316. The AV quality correlator 318 in the path display module 316 color codes the level of health for each link for display in the hierarchical tree 200 displayed in the UI 140. If the AV quality monitoring engine 100 is being used as a component of the channel health monitoring engine described in the Thukral reference, then the AV transport attributes engine 328 and the path display module 316 may routinely update the color coded health of the links in the UI 140 with every ping of the channel health monitoring engine described in the Thukral reference, e.g., once every twenty seconds, or once per minute, etc.

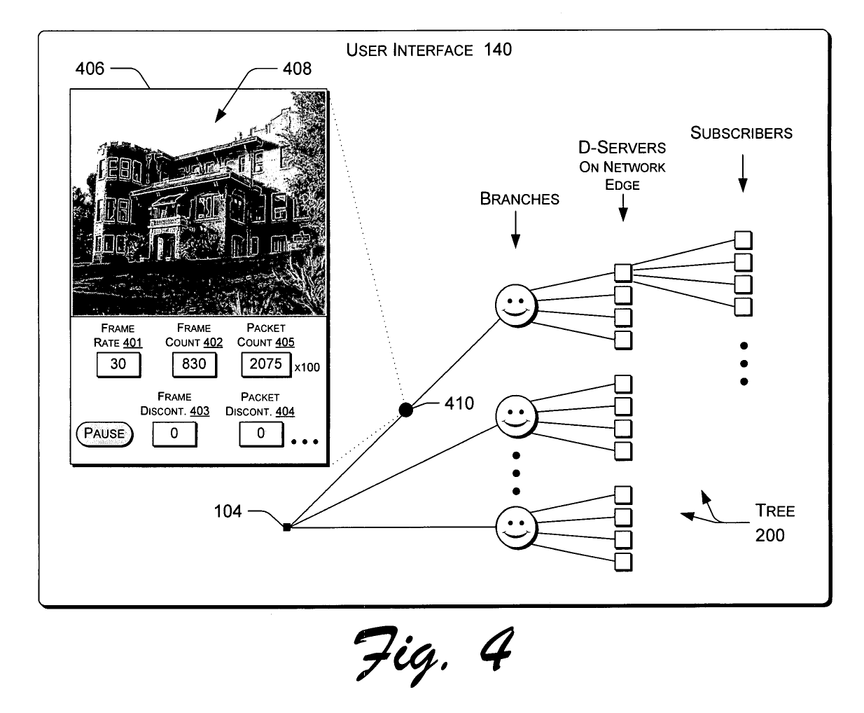

As shown in FIG. 4, the AV transport attributes engine 328 may also post an ongoing count of AV transport attributes (e.g., frame rate 401; ongoing frame count 402; frame discontinuities 403; packet discontinuities 404; ongoing packet count 405; etc.) to one or more panes or windows 406 that have been spawned for viewing the real-time rendering of video (frames) 408 from a selected test point, such as link 410, that has been designated by the operator via the test point selector 306.

Returning to FIG. 3, in the AV visualization engine 302, the IP address manager 310 tracks the IP addresses of the nodes, endpoints, or links selected by the test point selector 306 for visualization as rendered AV content. The stream rendering engine joins the multicast of video frames 408 carried by IP packets at a particular IP address and renders the video frames 408 into video images (and audio) in the spawned pane on the UI 140.

The comparison engine 312 may be included in the configuration to suggest differences between the AV transport attributes or the visual characteristics of two or more different panes of rendered AV content. That is, the comparison engine 312 indicates differences in image quality and/or transport attributes during side-by-side comparison of rendered AV content from two different points of the network.

The mode selector 314 may be included in some configurations to allow the operator to select how the AV quality monitoring engine 100 interprets selected features (nodes, endpoints, links) from the test point selector 306 that are to be visualized and compared side-by-side. If just one feature is selected, such as one node, then a side-by-side comparison may consist of a visualization of the IP stream flowing into the feature and the IP stream flowing out of the feature. But if two links or two nodes are selected for visualization and side-by-side comparison, then a choice of mode determines whether the inputs or the outputs of the two links or nodes are to be visualized and compared. In other words, the mode selector 314 chooses a default for where the test points are in certain visualization and comparison situations.

The scalable stream module 324 may be included in the AV quality monitoring engine 100 to ensure that when scalable bitstreams are being used in the IPTV network, like scalabilities are adopted for two or more AV contents being rendered for visualization and/or comparison. A DRM engine 326 decrypts encrypted streams at the scalability of each stream to be used for the visualization and/or comparison.

As mentioned, the above-described AV quality monitoring engine 100 is just one example of an AV quality monitoring engine 100. Other variations are also within the scope of the subject matter being described.

Exemplary User Interface

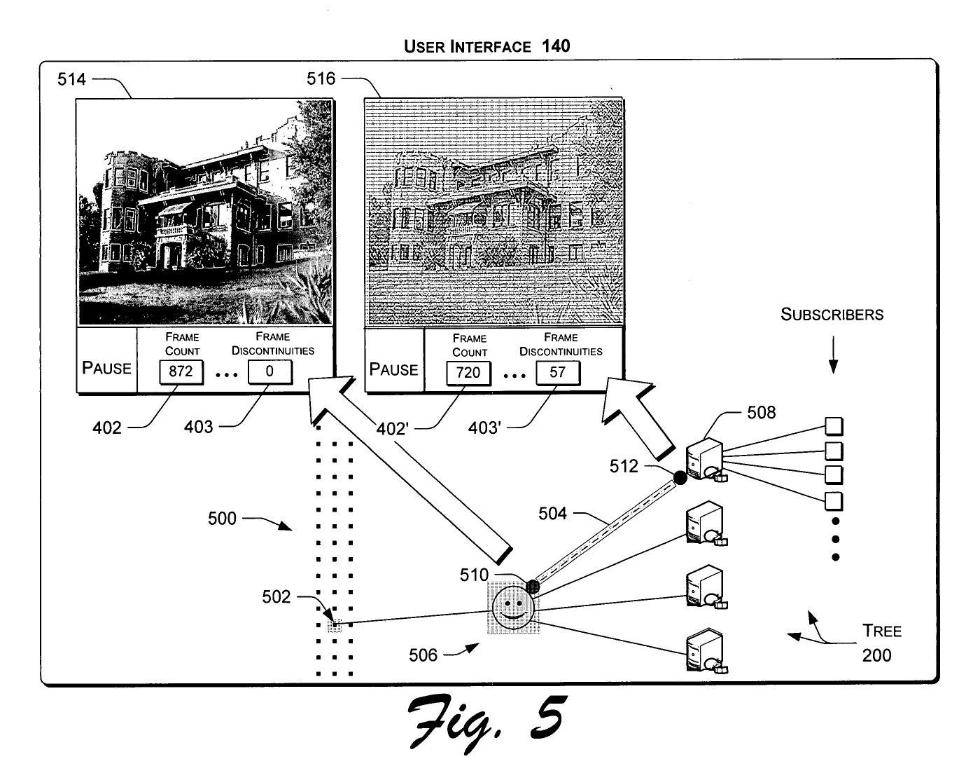

FIG. 5 shows an exemplary user interface 140 of the AV quality monitoring engine 100 in greater detail than in FIGS. 1-3. In one implementation, the displayed representation of the IPTV network is a user-collapsible hierarchical tree structure 200 that follows the tiered organization of the IPTV network itself. The tree structure allows a human operator to change levels of view and rapidly locate and visualize any link, component, or tap-in point for monitoring AV quality on the entire network without being overwhelmed with a visual representation that tries to display the entire network at once.

A partial representation of this hierarchical tree structure 200 of the IPTV network is typically displayed in the UI 140. The tree 200 is typically either collapsed into a high level view of the IPTV network or else expanded so that the view is zoomed-in to only a relevant segment of the IPTV network. In most cases, the displayed representation of a selected part of the IPTV network consists of just a few nodes and links of the IPTV network at a time, with each node selectable for expanding or collapsing to a connected segment of the channel path being viewed. Because the tiers of the actual IPTV network are hierarchical in relation to each other, moving across tiers in the UI 140 has the effect of zooming-in and zooming-out on the tree 200.

In order to display a collapsible representation of the tree 200, the end-to-end channel pathway engine 320 first discovers the complete distribution path for a channel. The exemplary UI 140 typically does not display the entire path at once, which would be cumbersome, but allows the operator to drill down to problems by expanding the tree from a higher level node at which a problem is indicated to relevant sub-branches of the tree.

In one implementation, the AV transport attributes engine 328 discovers the AV quality health of each part of the network—insofar as AV quality can be determined by IP transport attributes—and updates the links and nodes of the tree structure 200 in the UI 140 according to color codes for the levels of AV quality. Likewise, if there is a problem, then the problem node or problem link is indicated, e.g., by being surrounded with a box.

In one implementation, a node symbol in the displayed tree structure 200 can indicate a state of the links and nodes downstream from itself. A happy face (for example) as the node symbol of a network branch can indicate that there are no problems downstream in the downstream links and nodes associated with the branch, while a red outline around the node (for example) can indicate the presence of a problem further downstream that should be visible when the node is visually expanded on the UI 140. A culprit component causing a problem may be indicated by a red circle with a cross through it (for example). In other words, if the level of view is such that a node is being displayed but not its sub-branches, then a happy face indicates that no problem would be revealed by clicking to further expand the node to show more downstream detail. If the health is not optimal, then the happy face (for example) may be replaced by a different icon or color depending on degree of health.

The AV visualization engine 302 may not communicate directly with components, but instead may tune into the multicast and measure AV quality at the IP addresses. In one implementation, excellent AV quality between nodes is displayed as a green or solid line, while poor AV quality between nodes is displayed as a red or dashed line.

When a problem node or link is indicated in the UI 140, the problem is propagated to the next level of view as the operator collapses the tree 200. The highest level of view just displays the icons of the originating A-Servers 500 without showing distribution branches. In such a high-level view, if there is a problem far downstream from an A-Server 502, only the A-Server 502 is highlighted. As the operator unfolds the tree 200 to trace the problem, the UI 140 indicates by highlighting which branches to unfold at each level to arrive at the problem node or link.

It should be noted that many variations of the exemplary collapsible tree representation 200 of the IPTV network are possible within the same implementation of the exemplary channel health-monitoring system. For example, the UI 140 can display a subscriber at the highest level view and then expand to show links to the backend A-Server 502.

FIG. 5, only a portion of the hierarchical tree structure 200 is displayed as expanded from a top-level view. In the illustrated example, a link 504 between a branch nodal point 506 and a D-Server 508 has been selected for visualization and side-by-side comparison of the AV quality at its two endpoints 510 and 512.

The first window 514 of rendered AV content from the multicast as it flows at the first endpoint 510 shows a normal-looking rendition of the AV content, with a certain count of frames 402 per unit time and zero frame discontinuities 403. The second window 516 of rendered AV content from the multicast as it flows at the second endpoint 512 shows an inferior quality rendition of the same AV content, with a lower count of frames 402′ and some frame discontinuities 403′. In this case, the human operator needs to trace no further, as a comparison of the observed image quality shows that there is a problem with the link 504. Since each link 504 typically uses the Internet 102, the problem in this case may involve the Internet 102 itself. Then again, the operator could quickly check the network node on each side of the apparently faulty link 504.

To the human operator, the combination of side-by-side comparison of the real-time rendered AV content from two test point as well as side-by-side comparison of the transport attributes corresponding to each window of rendered AV content (i.e., meters such as a frame counter, frame rate indicator, frame discontinuity counter, packet counter, packet discontinuity counter, etc.) provide a powerful tool for isolating AV quality problems. The operator can typically learn the location and cause of an AV problem very quickly. For example, the operator can isolate whether the cause is the network, packet loss, why there are discontinuous frames, whether the node under test is overloaded and dropping packets or frames, etc.

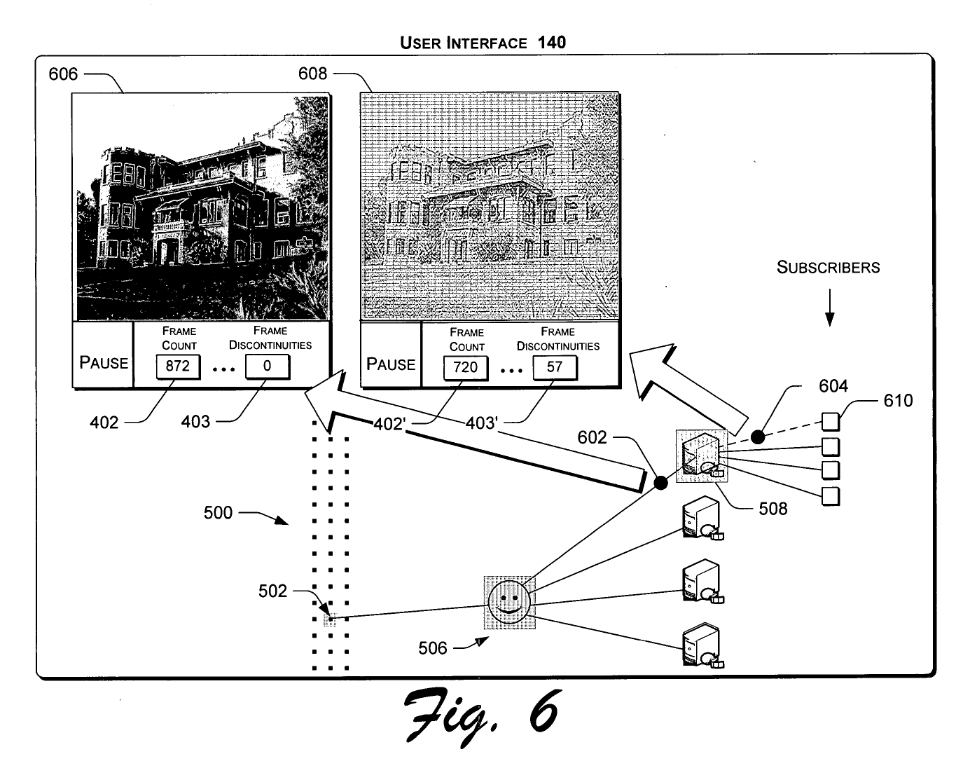

FIG. 6 shows the exemplary UI 140 in a state that displays a problem along a channel path. The test point selector 306 has selected a network node, D-Server 508, as a test point for AV quality, and the mode selector 314 is set so that when a single node is selected, a side-by-side visual comparison is automatically initiated on the AV stream input 602 to the selected node and output 604 from the selected node. Alternatively, in another mode, in order to test a singe node the operator manually selects one test point on either side of the node (e.g., 602, 604) via the test point selector 306 for a side-by-side visual comparison of AV quality.

In the illustrated case, the first window 606 of rendered AV content showing the multicast as it flows into the node 508 displays a normal-looking rendition of the AV content while the second window 608 of rendered AV content showing the multicast as it flows out of the node 508 displays an inferior quality rendition of the same AV content, with a lower count of frames per unit time and increased discontinuities over the first window 606. This visualization implicates the node 508, a D-Server, as the component responsible for poor AV quality at the end subscriber 610.

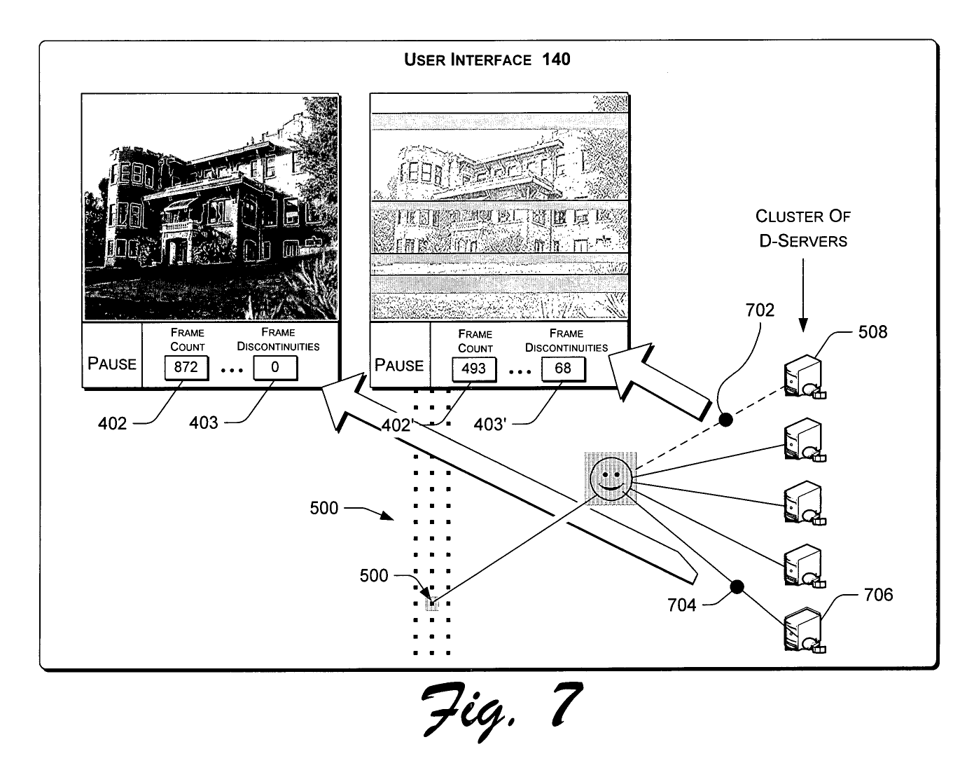

FIG. 7 shows the exemplary UI 140 in a state that displays a problem along a channel path. In this case, the test point selector 306 has selected two test points on different links (702, 704) of a branch of the IPTV network. The mode selector 314 has been set so that as a default, a singly selected node or link is tested at its downstream endpoint. Thus, in this case, the AV quality is being checked for each link (702, 704) as the AV stream enters respective D-Servers 508 and 706. A side-by-side comparison of rendered AV content from each link (702, 704) reveals that link 702 is faulty. Even when there is no problem, the UI 140 can be used to examine parts of the IPTV network to visualize the AV quality of components and links.

Exemplary Methods

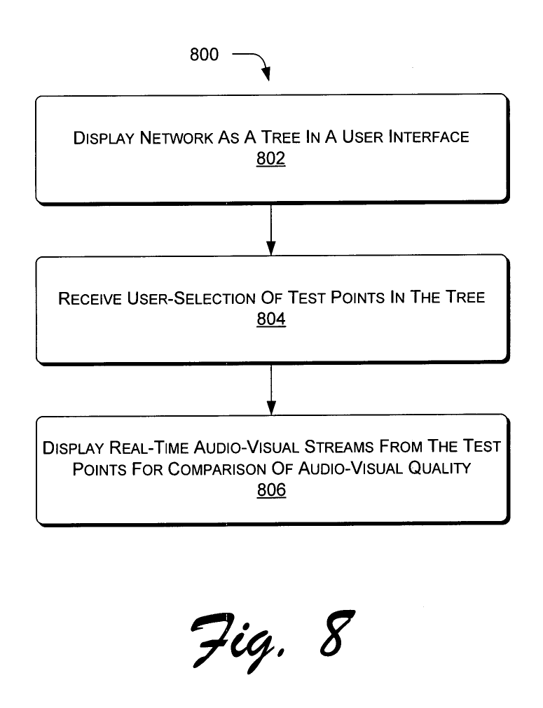

FIG. 8 shows an exemplary method 800 of real-time audio-visual quality monitoring. In the flow diagram, the operations are summarized in individual blocks. Parts of the exemplary method 800 may be performed by hardware, software, or combinations of both, for example, by components of the exemplary audio-visual quality monitoring engine 100.

At block 802, a network is displayed as a tree in a user interface. In one implementation, the exemplary method 800 shows a multi-tiered IPTV network as a collapsible tree consisting of network nodes and lines between the nodes signifying the distribution links between server nodes of the IPTV network. The displayed tree is typically collapsible at each node, so that branches downstream from a given node may be collapsed into the displayed node, by clicking with a mouse, for example.

In one implementation, each link of the displayed tree is color coded according to the AV quality of the bitstream flowing in the link. The system may poll the packet transport attributes of the network periodically, for example, once per minute, and update the color coding of each link accordingly.

At block 804, user-selection of one or more test points in the tree is received. In one implementation, a user clicks with a mouse on one of the color coded link lines described above to select the link for a closer look at the AV quality there. Several test points may be selected at once. For example, the two endpoints of a single link can be two test points, or the input and output of a server in the network can be two test points. Or, the user can select test points at different tiers or branches of the displayed tree.

At block 806, real-time AV streams associated with the test points are displayed in the user interface. In one implementation, each selected test point spawns a pane of real-time video (and/or audio). The real-time video is a rendering of the video frames being carried by the IP data packets flowing at the selected test points. In actuality, the real-time video associated with a selected test point is typically achieved by tuning to an IP address (joining the multicast) associated with the test point. That is, each distribution segment in an IPTV network typically interfaces with the Internet and uses an IP address for each interface. In one implementation, the spawned panes of real-time video are posted side-by-side in the UI together with numerical counters showing ongoing transport attributes, such as frame rate, current frame count, frame discontinuities, packet count, dropped packets, packet discontinuities, etc. The user can thus make a first-hand visual inspection and comparison of AV quality at the test points, and also compare the tabulation of transport attributes for the test points.

Conclusion

The subject matter described above can be implemented in hardware, software, firmware, etc., or combination thereof. In certain implementations, the subject matter may be described in the general context of computer-executable instructions, such as program modules, being executed by a computing device or communications device. Generally, program modules include routines, programs, objects, components, data structures, etc. that perform particular tasks or implement particular abstract data types. The subject matter can also be practiced in distributed communications environments where tasks are performed over wireless communication by remote processing devices that are linked through a communications network. In a wireless network, program modules may be located in both local and remote communications device storage media including memory storage devices.

The foregoing discussion describes exemplary real-time audio-visual quality monitoring for networks. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
representing at least part of an Internet Protocol television (IPTV) network as a tree in a user interface;
receiving a user-selection of a point on the tree representing a corresponding point in the IPTV network; and
rendering an audio-visual (AV) stream in the user interface, wherein the AV stream is associated with an Internet Protocol (IP) address corresponding to the selected point in the network.

2. The method as recited in claim 1, wherein the rendered AV stream displays a visual quality corresponding to a quality of video frames in the AV stream at the selected point in the network.

3. The method as recited in claim 1, wherein the representing comprises enabling collapsibility of the tree such that the user can collapse inferior parts of the tree representing inferior parts of a hierarchical organization of the IPTV network into related superior parts of the tree representing superior parts of the hierarchical organization of the IPTV network.

4. The method as recited in claim 1, further comprising discovering a path of a channel of the IPTV network, wherein the representing displays the path as the tree.

5. The method as recited in claim 1, wherein the receiving comprises receiving user-selection of multiple points on the tree and the rendering comprises rendering an AV stream in the user interface for each selected point.

6. The method as recited in claim 5, further comprising displaying the multiple AV streams side-by-side in the user interface for a visual comparison of respective AV qualities of the multiple rendered AV streams.

7. The method as recited in claim 5, further comprising displaying transport attributes of each of the multiple rendered AV streams in the user interface.

8. The method as recited in claim 7, wherein the transport attributes include one of a packet count, a packet discontinuity count, a video frame rate, a video frame count, and/or a video frame discontinuity count.

9. The method as recited in claim 1, further comprising displaying nodes of the IPTV network on the tree and color coding each link between two of the nodes according to an AV quality of the AV stream associated with each link.

10. The method as recited in claim 9, further comprising receiving a user-selection of one of the links and rendering side-by-side in the user interface an AV stream for each of the endpoints of the link.

11. The method as recited in claim 9, further comprising regularly monitoring the AV quality of each link and updating the color coding of each link.

12. The method as recited in claim 9, further comprising propagating an indication of an AV quality problem in one of the links to higher nodes of the tree being displayed in a collapsed state of the tree, wherein successive expansions of the tree at the indicated nodes eventually display the link that has the AV quality problem.

13. The method as recited in claim 12, further comprising troubleshooting an AV quality problem on the network by collapsing and expanding the tree and performing visual comparisons of AV qualities associated with different displayed links of the tree.

14. A method, comprising:
displaying an IPTV network in a user interface as a tree of links between nodes of the IPTV network;
regularly monitoring an audio-visual quality of video frames carried by a flow of IP data packets at each of the links;
dynamically color coding each of the links in the tree according to the monitored audio-visual quality of the video frames at each link;
receiving a user-designation of one of the links; and
displaying side-by-side real-time renderings of the video frames carried by the respective flows of IP data packets at the endpoints of the designated link.

15. The method as recited in claim 14, further comprising displaying transport attributes of each of the side-by-side real-time renderings of the video frames.

16. The method as recited in claim 14, further comprising displaying the tree as user-collapsible, wherein the user can collapse sub-branches of the tree connected to each node in the tree.

17. The method as recited in claim 16, wherein an audio-visual quality problem detected in one of the links by the regular monitoring is indicated for a chain of nodes and links in the tree, wherein during a user-collapse of the tree a visual indication of the problem persists to an un-collapsed node in the chain.

18. The method as recited in claim 17, wherein an audio-visual quality problem detected in one of the links by the regular monitoring automatically displays a portion of the tree related to the link that has the problem.

19. The method as recited in claim 18, wherein the audio-visual quality problem detected in one of the links by the regular monitoring automatically displays side-by-side real-time renderings of the video frames carried by the respective flows of IP data packets at the endpoints of the link that has the problem.

20. A system, comprising:
means for displaying an IPTV network in a user interface as a tree of links between nodes of the IPTV network;
means for receiving a user-designation of one of the links; and
means for displaying renderings of the video frames carried by the respective flows of IP data packets at the endpoints of the designated link.
